(19) United States
(12) Patent Application Publication
(10) Pub. No.: US 2018/0059773 A1
(43) Pub. Date: Mar. 1, 2018

(54) SYSTEM AND METHOD FOR PROVIDING HEAD-UP DISPLAY INFORMATION ACCORDING TO DRIVER AND DRIVING CONDITION

(71) Applicant: Korea Automotive Technology Institute, Cheonan-si (KR)

(72) Inventors: Sun Hong PARK, Asan-si (KR); Young Dal OH, Sejong-si (KR); Dong Woon RYU, Yongin-si (KR)

(73) Assignee: Korea Automotive Technology Institute, Cheonan-si (KR)

(21) Appl. No.: 15/249,976

(22) Filed: Aug. 29, 2016

(30) Foreign Application Priority Data
Aug. 29, 2016 (KR) 10-2016-0110032

(51) Int. Cl. G06F 3/01; G09G 3/00; G06F 3/03; G02B 27/01

(52) U.S. Cl. CPC G06F 3/011; G09G 3/002; G06F 3/0304; G06F 3/16; G02B 27/0149; G06F 3/017; G02B 27/0101

(57) ABSTRACT

The present disclosure relates to a system and method for providing information through a head-up display (HUD) based on a driver's condition and a driving condition. According to the present disclosure, a system for providing HUD information according to a driver's condition and a driving condition includes an information acquisition unit that acquires information on a driver's condition and information on a driving condition and a candidate command extraction unit that comprehensively and simultaneously take the information on a driver's condition and the information on a driving condition into consideration to propose a candidate command related to a function determined as being necessary to the driver through an HUD.

### CROSS-REFERENCE TO RELATED APPLICATION

This application claims priority to and the benefit of Korean Patent Application No. 10-2016-0110032, filed on Aug. 29, 2016, the disclosure of which is incorporated herein by reference in its entirety.

### BACKGROUND

### 1. Field of the Invention

The present disclosure relates to a system and method for providing information through a head-up display (HUD) based on a driver's condition and a driving condition.

### 2. Discussion of Related Art

A windshield moves beyond simply allowing viewing outside and providing protection from wind and rain to a smart window to which a cutting-edge electronics technology is applied.

A head-up display (HUD), which is a representative smart window technology, merely displays current speed of a vehicle, an amount of fuel remaining, navigation information, etc. and has a limitation of not being able to recommend a function based on a driver's condition or a driving condition.

### SUMMARY OF THE INVENTION

The present disclosure has been devised to solve the above problem and is directed to a system and method for providing head-up display (HUD) information according to a driver's condition and a driving condition in which a driver's condition and a driving condition are comprehensively and simultaneously taken into consideration to select a function of a device within a vehicle determined as being necessary to the driver and recommend the function by displaying the function on the HUD, thereby allowing the driver to smoothly execute the function of the device within the vehicle without altering the driver's gaze.

According to the present disclosure, a system for providing HUD information according to a driver's condition and a driving condition includes an information acquisition unit that acquires information on a driver's condition and information on a driving condition and a candidate command extraction unit that comprehensively and simultaneously take the information on a driver's condition and the information on a driving condition into consideration to propose a candidate command related to a function determined as being necessary to the driver through an HUD.

According to the present disclosure, a method for providing HUD information according to a driver's condition and a driving condition includes acquiring information on a driver's condition and information on a driving condition, extracting a candidate command related to a device in a traveling vehicle by comprehensively and simultaneously taking the information on a driver's condition and the information on a driving condition into consideration, and displaying the candidate command on the HUD.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram showing a system for providing head-up display (HUD) information according to a driver's condition and a driving condition according to an embodiment of the present disclosure;

FIG. 2 is a conceptual view showing an inside view of a vehicle to which the system for providing HUD information according to a driver's condition and a driving condition is applied;

FIG. 3 is a conceptual view showing a situation in which a warning message is being notified according to an embodiment of the present disclosure;

FIG. 4A and FIG. 4B are view showing a display of a device to be controlled according to an embodiment of the present disclosure;

FIG. 5A through FIG. 5C are view illustrating a display of a recommended candidate command for controlling an air conditioner according to an embodiment of the present disclosure; and

FIG. 6 is a flowchart showing a method for providing HUD information according to a driver's condition and a driving condition according to an embodiment of the present disclosure.

### DETAILED DESCRIPTION OF EXEMPLARY EMBODIMENTS

The above-mentioned objective, other objectives, advantages, and features of the present disclosure and a method for achieving the same should become apparent by referring to embodiments to be described below with reference to the accompanying drawings.

However, the present disclosure is not limited to the embodiments disclosed below and may be realized in various different forms. The embodiments below are merely for easily informing those of ordinary skill in the art to which the present disclosure pertains of the objective, configuration, and effects of the disclosure, and the scope of the present disclosure is defined by the claims below.

Meanwhile, the terms used herein are for describing the embodiments and are not for limiting the present disclosure. In the present specification, a singular expression includes a plural expression unless particularly mentioned otherwise. “comprises” and/or “comprising” used herein do not preclude the existence of or the possibility of adding one or more other elements, steps, operations, and/or devices.

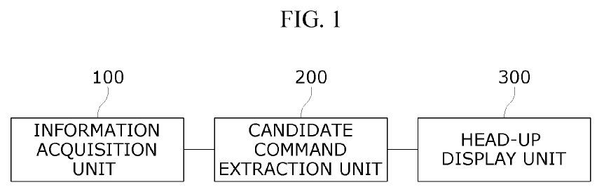

Referring to FIG. 1, a system for providing head-up display (HUD) information according to a driver's condition and a driving condition includes an information acquisition unit 100 that acquires information on a driver's condition and information on a driving condition and a candidate command extraction unit 200 that comprehensively and simultaneously take the information on a driver's condition and the information on a driving condition into consideration to propose a candidate command related to a function determined as being necessary to the driver through an HUD 300.

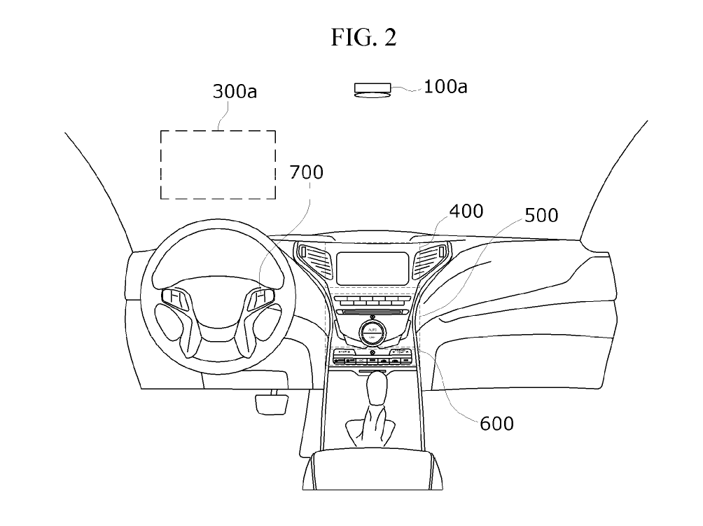

FIG. 2 is a view showing an inside view of a vehicle to which the system for providing HUD information according to a driver's condition and a driving condition is applied.

An HUD region 300a in which a graphic image is projected on the HUD 300 is disposed on glass in front of a driver.

According to an embodiment of the present disclosure, the HUD 300 is implemented by a method using a display panel in which a transparent display such as a liquid crystal display (LCD) or an organic light emitting diode (OLED) is installed at a surface of a front glass window of a vehicle or between a driver and the front glass window of the vehicle, a method using a laser in which a light-emitting material is applied on a front glass window of a vehicle and a laser beam is shot thereto, and a method using projection in which an optical projection device is embedded in a dashboard of a vehicle, an image is projected upward toward a front glass window of the vehicle, and a part of the projected image is reflected from the glass window and becomes visible to a driver.

The information acquisition unit 100 typically uses a camera 100a disposed in a vehicle to acquire information on a driver's condition and recognizes the driver's pupils, nodding that occurs in drowsy driving, and motions of the driver's arms (e.g., whether the driver is manipulating a smartphone or is massaging the neck or a shoulder to get rid of drowsiness) to acquire driving condition information related to a driving concentration level of the driver and driver's condition information related to drowsiness (fatigue).

The information acquisition unit 100 includes the camera 100a illustrated in FIG. 2 to acquire the driver's condition information described above and may also receive biometric information from a biometric sensor attached to a steering wheel 700.

In addition, the information acquisition unit 100 acquires driving condition information, mainly internal environment information related to temperature inside a vehicle, oxygen saturation, vehicle speed, noise, and vibration and external environment information related to a driving path, a construction section, weather, and road surface.

Generally, when a driver becomes drowsy while driving, the driver opens a window to refresh air, plays music, or operates an air conditioner (probability of drowsy driving increases in cold winter when vehicle inside is heated) to adjust temperature in the vehicle.

Danger of accidents would decrease when a driver becomes aware of drowsiness and prevents drowsy driving through subsequent actions above. However, in most cases, a driver does not become aware of the drowsy driving or forcibly stays awake and continues driving without taking a preventive action, and thus the danger of accidents considerably increases.

According to an embodiment of the present disclosure, the candidate command extraction unit 200 comprehensively and simultaneously takes information on a driver's condition and information on a driving condition into consideration to extract a candidate command related to a function determined as being necessary to the driver while driving and transmits the extracted candidate command to the HUD 300.

Hereinafter, embodiments of extracting a candidate command based on information on a driver's condition and information on a driving condition will be described to assist those of ordinary skill in the art to understand the present disclosure, but the scope of the present disclosure is not limited to the embodiments to be described below.

### First Embodiment

### When a Driving Concentration Level of a Driver is Low Due to Manipulating a Smartphone While Driving

Through the camera 100a or a separate sensor, the information acquisition unit 100 determines that a driving concentration level is low due to a driver manipulating a smartphone while driving.

Here, the driving concentration level of the driver may be acquired when: 1) an amount of time in which the driver does not manipulate a vehicle steering wheel with both hands increases to a predetermined amount of time or larger; 2) the driver does not gaze forward and gazes another region for a predetermined amount of time or larger; and 3) it is determined, as a result of interpreting an image recognized by a camera, that the driver is manipulating a smartphone.

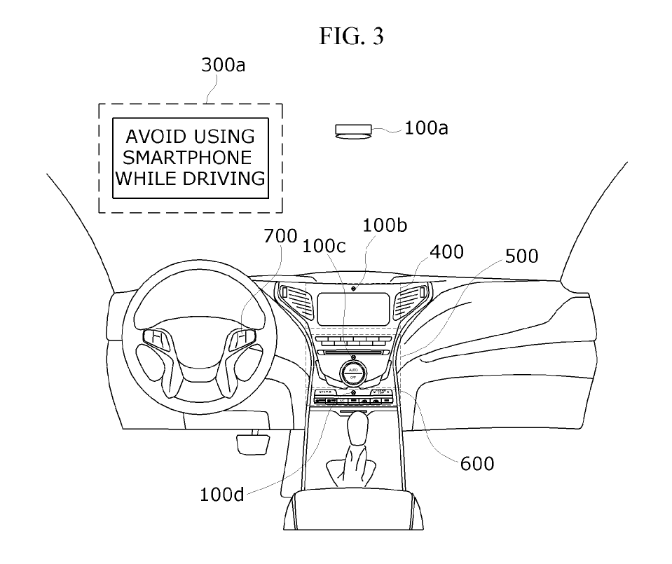

Since manipulating a smartphone while driving has a great negative influence on driving stability, first, the candidate command extraction unit 200 transmits a warning message through the HUD 300 (FIG. 3. “Avoid using smartphone while driving”).

Here, the candidate command extraction unit 200 may control a device in the vehicle to provide a warning alarm sound to the driver in addition to transmitting the warning message, may additionally vibrate the steering wheel, or may also vibrate the driver seat.

In addition, the candidate command extraction unit 200 may also communicate with a smartphone connected thereto by Bluetooth for the above warning message to be directly displayed on the smartphone.

In addition, when a vehicle speed is a preset value or higher (e.g., driving at a high speed of 70 km/h or higher) according to the internal environment information acquired by the information acquisition unit 100, or when the vehicle is in a curved section or a section with frequent accidents according to the external environment information acquired by the information acquisition unit 100, the candidate command extraction unit 200 determines the driver's smartphone manipulation while driving to be even more dangerous and transmits the warning message and a warning alarm (sound or vibration) described above.

### Second Embodiment

### When Drowsy Driving Occurs

By recognizing a driver's pupils and nodding, the information acquisition unit 100 determines whether drowsy driving is occurring.

When it is determined that drowsy driving is occurring according to the information on the driver's condition and it is determined that temperature inside the vehicle is higher or lower than the outside temperature by 5° C. or more, the candidate command extraction unit 200 displays an inquiry message related to whether an air conditioner should be controlled through the HUD 300.

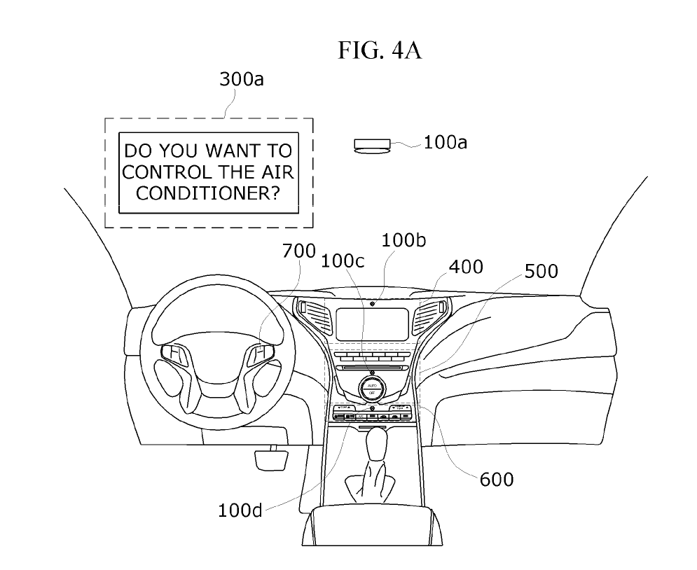

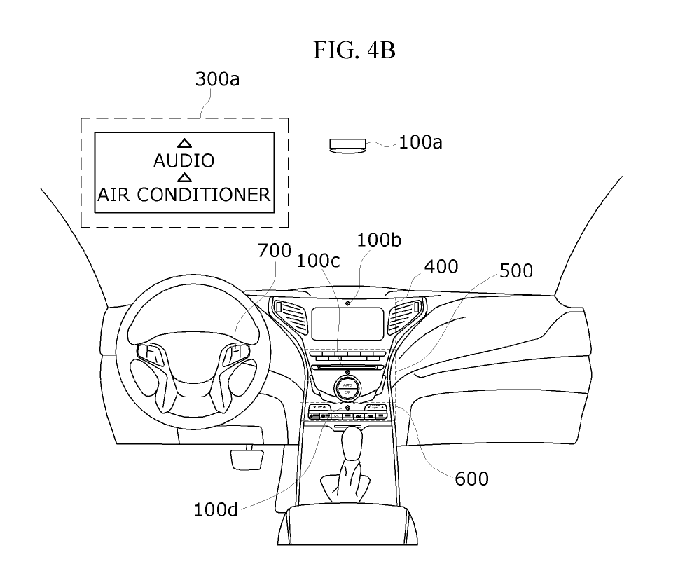

That is, as illustrated in FIG. 4A, an inquiry message, “Do you want to control the air conditioner?”, may be displayed, and a subsequent command may be displayed according to a response to the inquiry message. As illustrated in FIG. 4B, according to the response to the inquiry message (this process may be omitted), a device inside the vehicle to be manipulated that prevents drowsy driving such as an air conditioner, an audio system, and windows may also be displayed.

Here, the order in which the air conditioner, the audio system, and the windows are displayed is determined based on the internal environment information and the external environment information acquired by the information acquisition unit 100, and accumulated history information related to functions executed by the driver is taken into consideration in proposing prioritized order for candidate commands

For example, when the driver's behavior pattern shows that the most frequent action performed by the driver in case of drowsy driving is opening a window, a candidate command related to an operation of opening the window may be displayed first as selectable, unlike in FIG. 4B.

However, according to the present disclosure, since a driving condition of the vehicle is also comprehensively and simultaneously taken into consideration, priority for a candidate command related to controlling the air conditioner may be set higher than that related to the operation of opening the window when, for example, it is raining or dust, due to a construction section in front of the vehicle, is expected to enter the vehicle when the window is opened.

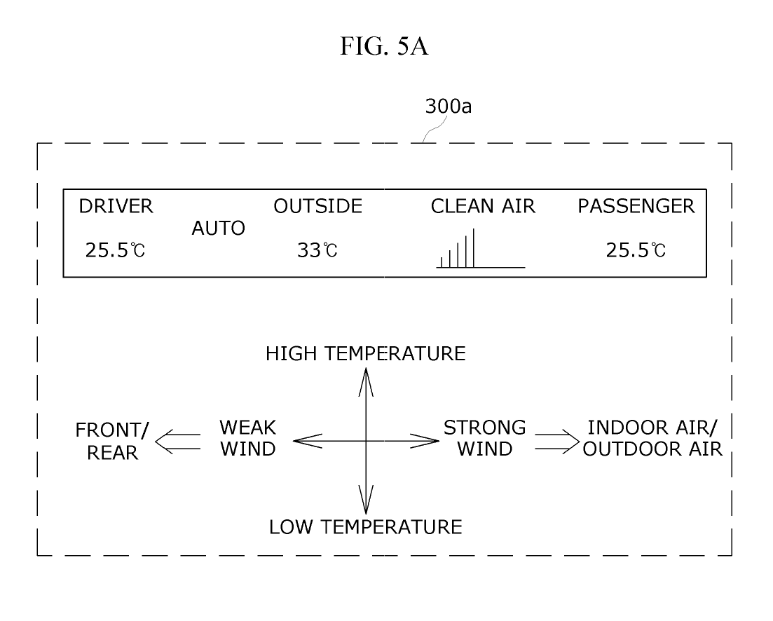

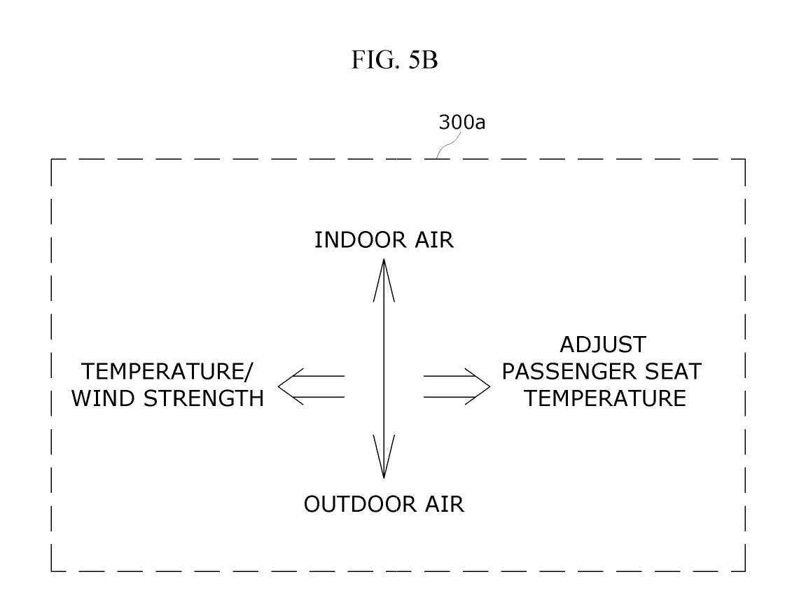

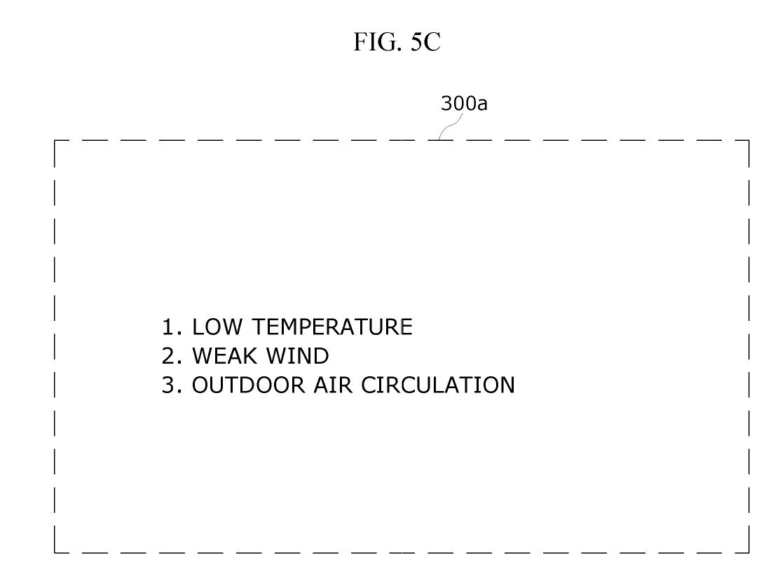

According to FIG. 5A, the candidate command extraction unit 200 of the present disclosure transmits current settings information of a device (air conditioner) that executes a corresponding function of a candidate command to be displayed together with a candidate command in the HUD region 300a.

As illustrated in FIG. 5, according to information on a driver's condition (drowsy driving) and information on a driving condition (rainy weather, and the like is considered), a gesture, a spoken word, a steering button clicking direction, etc. are mapped to a candidate command performing each function and proposed.

For example, temperature may be increased or decreased, and wind strength may be increased or decreased by a gesture (FIG. 5A), indoor air circulation may be adjusted with outdoor air circulation in case of drowsy driving (FIG. 5B), and a voice recognition candidate command may be displayed as in FIG. 5C.

Referring to FIG. 5C, when it is determined that drowsy driving is currently caused by heating the vehicle interior, the candidate command extraction unit extracts “lower the temperature,” “decrease the wind strength,” and “outdoor air circulation” as candidate commands and displays the candidate command through the HUD region 300a.

According to the present disclosure, the driver may become aware of drowsy driving and may intuitively execute a corresponding command through a gesture, voice recognition, or clicking a steering button by checking controllable functions of the air conditioner for preventing drowsy driving through the HUD, even without any advance learning.

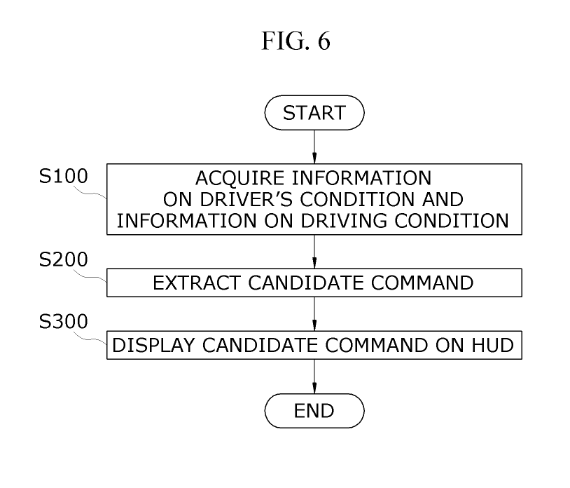

FIG. 6 is a flowchart showing a method for providing HUD information according to a driver's condition and a driving condition according to an embodiment of the present disclosure.

According to the present disclosure, the method for providing HUD information according to a driver's condition and a driving condition includes acquiring information on a driver's condition and information on a driving condition (S100), extracting a candidate command related to a device in a traveling vehicle by comprehensively and simultaneously taking the information on a driver's condition and the information on a driving condition into consideration (S200), and displaying the candidate command on an HUD (S300).

Step S100 is a step in which one or more results of image analysis in a vehicle and biometric information acquisition are taken into consideration to acquire information on a driving condition and whether drowsy driving is occurring.

As described above, the information on a driver's condition acquired in the present disclosure includes information on the driving concentration level of the driver (e.g., the driving concentration level is low when the driver manipulates a smartphone while driving) and whether drowsy driving is occurring.

In addition to the information on a driver's condition, Step S100 acquires information on a driving condition including internal/external environment information on the vehicle.

Here, the internal environment information includes temperature inside a vehicle, oxygen saturation, vehicle speed, noise, and vibration, and the external environment information includes a driving path, a construction section, weather, and road surface.

Based on a record database of the driver, Step S200 first extracts a candidate command that performs a corresponding function expected to be desired by the driver when based on the currently acquired information on the driver's condition and information on the driving condition (e.g., opening a window, for the driver whose most-frequently performed action in case of drowsy driving is opening a window).

However, although Step S200 is based on the record database of the driver, since information on the driving condition is also comprehensively and simultaneously taken into consideration with the information on the driver's condition, a candidate command related to opening a window may be excluded and a candidate command related to controlling the air conditioner may first be displayed when, for example, it is raining, a construction section is ahead of the vehicle, or rainwater or dust is expected to enter the vehicle due to a poor pavement condition of a road when a window is opened.

In addition, Step S200 matches a commanding method related to one or more of a gesture command, a voice command, clicking a command button related to a candidate command that executes each function of a corresponding device to be controlled (e.g., an air conditioner) with a candidate command and extracts the commanding method.

In Step S300, since the driver may check a displayed candidate command and select a corresponding controlling function based on information on a current condition of the driver and information on a driving condition without any advance learning, the driver may smoothly execute functions within the vehicle while keeping one's gaze toward the front.

According to the present disclosure, by taking a driver's condition (fatigue, overloading, drowsiness, carelessness, etc.) and a driving condition (vehicle speed, driving noise, vibration, illumination, humidity, etc.) into consideration, a system and method for providing HUD information according to a driver's condition and a driving condition is capable of recommending and providing a candidate command so that manipulation of a device within a vehicle can be conveniently controlled.

According to the present disclosure, a driver receives available control information of a device within a vehicle recommended and selected according to the driver's condition and a driving condition and a command list related thereto through an HUD without advance learning, and thus an intuitive command can be input.

Effects of the present disclosure are not limited to those mentioned above, and other unmentioned effects should be clearly understood by those of ordinary skill in the art from the description above.

The present disclosure has been described above by focusing on the embodiments thereof. Those of ordinary skill in the art to which the present disclosure pertains should understand that the present disclosure may be realized in a modified form within the scope not departing from essential features of the present disclosure. Thus, the embodiments disclosed herein should be considered as being illustrative instead of limiting. The scope of the present disclosure is not shown in the description above but shown in the claims below, and all modifications within the scope equivalent to the claims should be construed as belonging to the present disclosure.

The components described in the exemplary embodiments of the present invention may be achieved by hardware components including at least one DSP(digital signal processor), a processor, a controller, an ASIC(application specific integrated circuit), a programmable logic element such as an FPGA(field programmable gate array), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

### DESCRIPTION OF REFERENCE NUMERALS

| | |
|---|---|
| 100: Information acquisition unit | 200: Candidate command extraction unit |
| 300: Head-up display | 400: Navigation |
| 500: Audio | 600: Air conditioner |
| 700: Steering wheel | |
| manipulation button | |

What is claimed is:

1. A system for providing head-up display (HUD) information according to a driver's condition and a driving condition, the system comprising:
an information acquisition unit configured to acquire information on a driver's condition and information on a driving condition; and
a candidate command extraction unit configured to comprehensively and simultaneously take the information on a driver's condition and the information on a driving condition into consideration to propose a candidate command related to a function determined as being necessary to the driver through an HUD.

2. The system of claim 1, wherein the information acquisition unit acquires the information on a driving condition related to a driving concentration level of the driver and the information on the driver's condition related to one or more of drowsiness, fatigue, and carelessness.

3. The system of claim 1, wherein the information acquisition unit acquires the information on a driving condition related to at least one of internal environment information and external environment information of a vehicle.

4. The system of claim 3, wherein the information acquisition unit acquires the internal environment information related to temperature inside a vehicle, oxygen saturation, vehicle speed, noise, and vibration.

5. The system of claim 3, wherein the information acquisition unit acquires the external environment information related to a driving path, a construction section, weather, and road surface.

6. The system of claim 1, wherein, based on a driving habit record database of the driver, the candidate command extraction unit recognizes the information on a driver's condition and a real time potential intention according thereto to recognize the information on a driver's condition as categorized condition information to match the categorized condition information with the information on a driving condition and comprehensively and simultaneously consider the information on a driver's condition and the information on a driving condition.

7. The system of claim 1, wherein the candidate command extraction unit makes an inquiry about whether an extracted recommended function should be executed according to a result of comprehensively and simultaneously taking the information on a driver's condition and the information on a driving condition into consideration.

8. The system of claim 1, wherein the candidate command extraction unit proposes a plurality of recommended candidate commands related to functions of a device in a vehicle to be controlled by making a list of the plurality of recommended candidate commands

9. The system of claim 1, wherein the candidate command extraction unit takes accumulated history information related to functions actually executed by the driver according to the information on a driver's condition and the information on a driving condition into consideration to propose prioritized order for candidate commands

10. The system of claim 1, wherein the candidate command extraction unit maps one or more of a gesture, a spoken word, a steering button clicking direction, etc. corresponding to a command that executes the candidate command with the candidate command to be proposed together with the candidate command

11. The system of claim 1, wherein the candidate command extraction unit controls current settings information on a device that executes a corresponding function of the candidate command to be displayed together with the candidate command

12. A method for providing head-up display (HUD) information according to a driver's condition and a driving condition, the method comprising:
(a) acquiring information on a driver's condition and information on a driving condition;
(b) extracting a candidate command related to a device in a traveling vehicle by comprehensively and simultaneously taking the information on a driver's condition and the information on a driving condition into consideration; and
(c) displaying the candidate command on the HUD.

13. The method of claim 12, wherein, in (a), one or more of results of an image analysis in a vehicle and biometric information acquisition are taken into consideration to acquire information on a driving condition and whether drowsy driving is occurring.

14. The method of claim 12, wherein, in (a), information on driving condition related to internal environment information and external environment information of a vehicle are acquired from an internal communication system and an external server.

15. The method of claim 12, wherein, in (b), potential intention of the driver is recognized from the information on a driver's condition based on a record database of the driver, the recognized potential intention is matched with the information on a driving condition to be comprehensively and simultaneously taken into consideration to extract a function determined as being necessary to the driver, and a candidate command for executing the corresponding function is extracted.

16. The method of claim 12, wherein, in (b), accumulated history information related to functions actually executed by the driver according to the information on a driver's condition and the information on a driving condition are taken into consideration to propose prioritized order for candidate commands

17. The method of claim 12, wherein, in (c), an execution commanding method related to one or more of a gesture command, a voice command, clicking a command button related to the candidate command is matched with the candidate command to be displayed.

18. The method of claim 12, wherein, in (c), current information of a device that executes the corresponding function of the candidate command is displayed together with the candidate command
